(19) United States
(12) Patent Application Publication
(10) Pub. No.: US 2024/0363284 A1
(43) Pub. Date: Oct. 31, 2024

(54) TRANSFORMER

(71) Applicant: TDK XIAMEN CO., LTD., Xiamen (CN)

(72) Inventors: Ge LI, Xiamen (CN); ZhenSheng LIU, Xiamen (CN); XueSong GUO, Xiamen (CN)

(73) Assignee: TDK XIAMEN CO., LTD., Xiamen (CN)

(21) Appl. No.: 18/647,279

(22) Filed: Apr. 26, 2024

(30) Foreign Application Priority Data
Apr. 27, 2023 (CN) 202310472982.3

(51) Int. Cl. H01F 27/34; H01F 27/24; H01F 27/36

(52) U.S. Cl. CPC H01F 27/346; H01F 27/24; H01F 27/363

(57) ABSTRACT

A transformer includes a core and a metal shield. The core includes a bottom plate, a middle leg protruding from the bottom plate, and a first outer leg and a second outer leg located opposite to each other along a first axis and protruding from the bottom plate on both sides of the middle leg. A width of a first opening, formed between the first outer end surface and the third outer end surface, along the first axis is smaller than a width of a second opening, formed between the second outer end surface and the fourth outer end surface, along the first axis.

### CROSS-REFERENCE TO RELATED APPLICATIONS

The present application claims priority from Chinese Patent Application No. 202310472982.3 filed on Apr. 27, 2023, the entire contents of which are hereby incorporated by reference.

### BACKGROUND OF THE DISCLOSURE

The present invention relates to a transformer.

For example, as shown in Patent Document 1, various techniques are conventionally proposed for transformers used as leakage transformers, etc. The transformer includes, for example, coils (primary coil and secondary coil), a core, and a metal case for housing them. In this type of transformer, it is possible to dissipate heat from the coils or the core to the outside via the case. In particular, the closer the distance between the core and the case, the smaller the thermal resistance between them, and the heat dissipation of the transformer can be improved. On the other hand, the closer the distance between the core and the case, the easier it is for leakage magnetic flux to interlink with the case, and the easier it is for eddy currents to occur in the case. This results in the problem of increased loss in the transformer and reduced efficiency of the transformer.

Then, the following two techniques are conventionally known as techniques for reducing the loss of transformers. The first technique is to increase the distance between the core and the case. The second technique is to dispose a magnetic material between the core and the case so as to block leakage magnetic flux. In both of the first and second techniques, leakage magnetic flux is less likely to interlink with the case, and the loss of transformers can be reduced.

However, the first technique has the following problem: the size of the transformer increases depending on the distance between the core and the case, and it is not possible to meet the demand for miniaturization. Also, the second technique has the following problem: since a magnetic material is added to the components of transformer, the manufacturing costs increases, and it is difficult to fix the magnetic material.
Patent Document 1: JPH11345724 (A)

### BRIEF SUMMARY OF THE INVENTION

A transformer according to the present disclosure comprises:
a core including:
   a bottom plate;
   a middle leg protruding from the bottom plate; and
   a first outer leg and a second outer leg located opposite to each other along a first axis and protruding from the bottom plate on both sides of the middle leg; and
a metal shield in which the core is placed;
wherein
the first outer leg includes:
   a first outer end surface opposing to the shield; and
   a second outer end surface located on the opposite side of the first outer end surface with respect to a direction perpendicular to the first outer end surface,
the second outer leg includes:
   a third outer end surface opposing to the shield; and
   a fourth outer end surface located on the opposite side of the third outer end surface with respect to a direction perpendicular to the third outer end surface, and
a width of a first opening, formed between the first outer end surface and the third outer end surface, along the first axis is smaller than a width of a second opening, formed between the second outer end surface and the fourth outer end surface, along the first axis.

In the transformer according to the present disclosure, the first outer leg includes a first outer end surface opposing to the shield, and the second outer leg includes a third outer end surface opposing to the shield. Thus, the first opening formed between the first outer end surface and the third outer end surface is necessarily opened toward the shield. In this way, since the first opening is opened toward the shield, the first opening functions as a heat dissipation path. As a result, heat from the core or a coil is easily dissipated toward the shield, and the heat dissipation of the transformer can be improved. Moreover, for example, when the shield is made of a case and the inside of the case is filled with a heat dissipation resin, the heat dissipation resin flows out toward the bottom of the case via the first opening. Thus, the heat dissipation resin is easily distributed all over in the case, and the heat dissipation of the transformer can further be improved.

Moreover, a width of a first opening, formed between the first outer end surface and the third outer end surface, along the first axis is smaller than a width of a second opening, formed between the second outer end surface and the fourth outer end surface, along the first axis. Since the width of the first opening along the first axis is smaller than the width of the second opening along the first axis, leakage magnetic flux is less likely to flow out toward the shield via the first opening. Thus, leakage magnetic flux is less likely to interlink with the shield, and it is possible to prevent eddy currents from occurring in the shield. This makes it possible to reduce the loss of the transformer and to increase the efficiency of the transformer.

Accordingly, in the transformer according to the present disclosure, unlike the conventional first technique, it is not necessary to increase the distance between the core and the shield for the purpose of reducing the loss of the transformer, and the transformer can be downsized. Moreover, unlike the conventional second technique, it is not necessary to dispose a magnetic material between the core and the shield so as to block leakage magnetic flux, and the manufacturing cost does not increase. Thus, according to the present disclosure, it is possible to provide a small-sized, low-loss transformer without increasing the manufacturing cost.

The width of the first opening along the first axis may be smaller than a width of the middle leg along the first axis. When the width of the first opening along the first axis is smaller than a width of the middle leg along the first axis, leakage magnetic flux is less likely to flow out toward the shield via the first opening. Thus, leakage magnetic flux is less likely to interlink with the shield, and it is possible to effectively prevent eddy currents from occurring in the shield. Moreover, for example, when a coil is disposed around the middle leg, the outer circumferential surface of the coil is less likely to be exposed to the outside of the first opening (i.e., the shield side). Thus, in this respect as well, leakage magnetic flux is less likely to interlink with the shield, and it is possible to effectively prevent eddy currents from occurring in the shield.

The middle leg may be closer to the second opening than to the first opening. In this case, for example, when a coil is disposed around the middle leg, the coil is disposed closer to the second opening than to the first opening. In this way, when the coil is unevenly located closer to the second opening, the outer circumferential surface of the coil is less likely to be exposed to the outside of the first opening (i.e., the shield side). Thus, leakage magnetic flux is less likely to interlink with the shield, and it is possible to effectively prevent eddy currents from occurring in the shield.

The first outer leg may include a first inner side surface extending along an outer circumferential surface of the middle leg and a first outer side surface intersecting the first outer end surface and the second outer end surface, and a thickness between the first outer end surface and the first inner side surface may be larger than a thickness between the first outer side surface and the first inner side surface. In this case, the cross-sectional area of the magnetic path formed by the first outer leg can be secured, and the magnetic characteristics of the transformer can be improved. Moreover, for example, when a coil is disposed around the middle leg, the outer circumferential surface of the coil is disposed at a position spaced from the first opening toward the second opening according to the thickness between the first outer end surface and the first inner side surface. Thus, the outer circumferential surface of the coil is less likely to be exposed to the outside of the first opening (i.e., the shield side). As a result, leakage magnetic flux is less likely to interlink with the shield, and it is possible to effectively prevent eddy currents from occurring in the shield.

The first outer leg may include a first inner side surface curved along an outer circumferential surface of the middle leg and a first outer side surface intersecting the first outer end surface and the second outer end surface, and a thickness between the first inner side surface and the first outer side surface may increase toward the second opening. In this case, the first outer leg is curved toward the center of the bottom plate along the outer circumferential surface of the middle leg on the second opening side. Thus, the width of the second opening along the first axis is reduced, and the magnetic path formed by the first outer leg and the second outer leg can easily form a closed magnetic path. As a result, more magnetic flux passes through the first outer leg and the second outer leg, and the magnetic characteristics of the transformer can be improved.

The first outer leg may include a first outer side surface intersecting the first outer end surface and the second outer end surface, and a ridge portion between the first outer end surface and the first outer side surface may be chamfered. In this case, it is possible to prevent cracks or chips from occurring on the ridge portion between the first outer end surface and the first outer side surface. This makes it possible to prevent variations in the cross-sectional area of the magnetic path formed by the first outer leg and to prevent variations in the magnetic characteristics of the transformer.

A bottom end surface extending along the first axis may be formed at an outer edge of the bottom plate at least between the first outer end surface and the third outer end surface, and the bottom end surface may be a flat surface. When the bottom end surface is a flat surface, compared to the case where the bottom end surface is a concave surface, a gap is less likely to be formed between the bottom end surface and the shield. Thus, leakage magnetic flux is less likely to flow out to the outside of the bottom plate via the gap. As a result, leakage magnetic flux is less likely to interlink with the shield, and it is possible to effectively prevent eddy currents from occurring in the shield.

No step may be formed between the first outer end surface and the bottom end surface, and no step may be formed between the third outer end surface and the bottom end surface. In this case as well, a gap is less likely to be formed between the bottom end surface and the shield, and leakage magnetic flux is less likely to flow out to the outside of the bottom plate via the gap. As a result, leakage magnetic flux is less likely to interlink with the shield, and it is possible to effectively prevent eddy currents from occurring in the shield.

### BRIEF DESCRIPTION OF THE SEVERAL VIEWS OF THE DRAWING

FIG. 1 is a perspective view of a transformer according to an embodiment of the present disclosure;

FIG. 2 is a partially exploded perspective view of the transformer shown in FIG. 1;

FIG. 3A is a perspective view of a bobbin shown in FIG. 2;

FIG. 3B is a side view of the bobbin shown in FIG. 3A;

FIG. 4 is a cross-sectional view taken along the line IV-IV shown in FIG. 1;

FIG. 5 is a side view of cores shown in FIG. 2 as seen along the Y-axis;

FIG. 6 is a side view of a modified example of the cores shown in FIG. 5;

FIG. 7 is a side view of another modified example of the cores shown in FIG. 5; and

FIG. 8 is a perspective view of a modified example of the cores shown in FIG. 6.

### DETAILED DESCRIPTION OF THE INVENTION

Hereinafter, an embodiment of the present disclosure is described with reference to the drawings. Note that, the contents shown in the drawings are merely schematic and illustrative for understanding the present disclosure, and the appearance, dimensional ratios, etc. may be different from the actual one. Moreover, the present disclosure is not limited to the following embodiment.

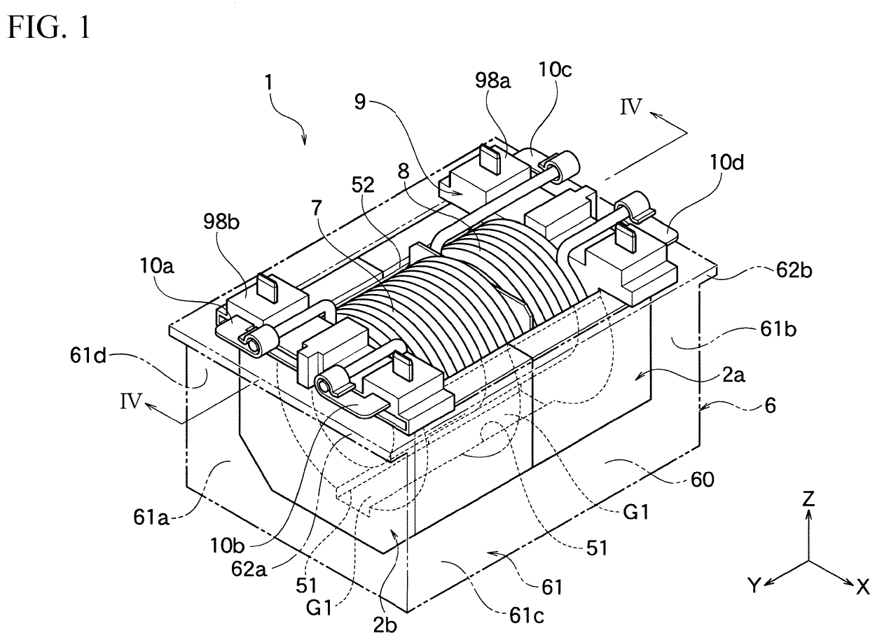

A transformer 1 according to an embodiment of the present disclosure shown in FIG. 1 functions as, for example, a leakage transformer and is used in a power supply circuit of an in-vehicle charger or various electric devices. As an example, the transformer 1 includes a core 2a, a core 2b, a case 6, a first wire 7, a second wire 8, a bobbin 9, and terminals 10a to 10d. The configuration of the transformer 1 is not limited to the configuration shown in FIG. 1 and may appropriately be changed without departing from the scope of the present disclosure.

In FIG. 1, the X-axis and the Y-axis are parallel to two orthogonal sides of a bottom portion 60 of the case 6. The Z-axis is an axis perpendicular to the X-axis and the Y-axis. In the following description, for each of the X-axis, the Y-axis, and the Z-axis, the direction toward the center of the transformer 1 is referred to as the inner side, and the direction away from the center of the transformer 1 is referred to as the outer side.

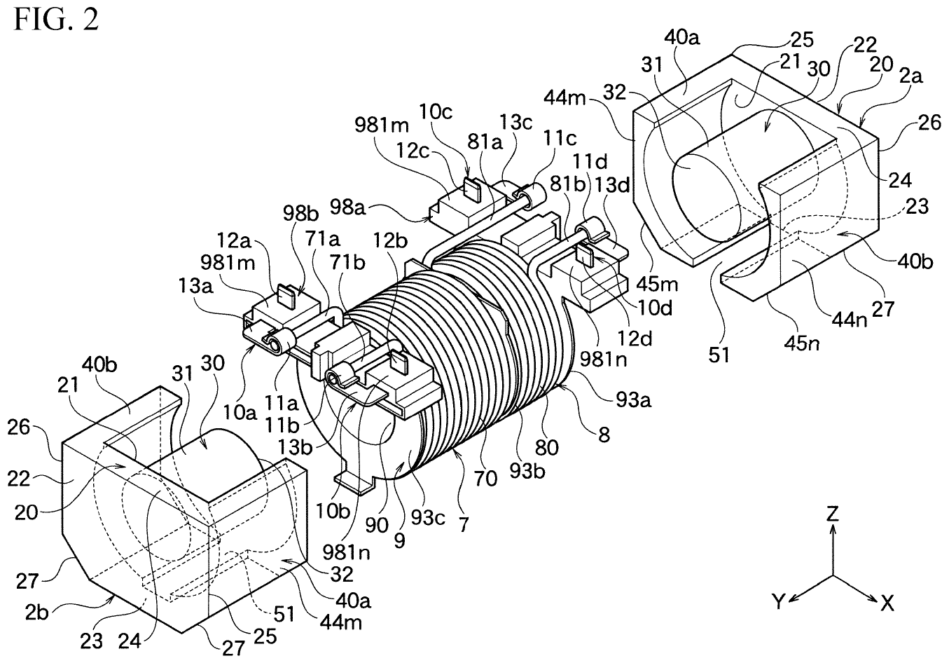

As shown in FIG. 2, the first wire 7 includes a first winding portion 70 and first lead portions 71a and 71b led out from the first winding portion 70. The first winding portion 70 is formed by winding the first wire 7 in a spiral shape around the outer circumferential surface of the bobbin 9. The first lead portion 71a is located between the first winding portion 70 and one end of the first wire 7. The first lead portion 71b is located between the first winding portion 70 and the other end of the first wire 7.

The second wire 8 includes a second winding portion 80 and second lead portions 81a and 81b led out from the second winding portion 80. The second winding portion 80 is formed by winding the second wire 8 in a spiral shape around the outer circumferential surface of the bobbin 9. The second lead portion 81a is located between the second winding portion 80 and one end of the second wire 8. The second lead portion 81b is located between the second winding portion 80 and the other end of the second wire 8.

One of the first winding portion 70 and the second winding portion 80 is a primary coil, and the other of the first winding portion 70 and the second winding portion 80 is a secondary coil. The first wire 7 and the second wire 8 have a conductive core such as a round wire, a rectangular wire, a twisted wire, a Litz wire, and a braided wire made of copper, etc. The first wire 7 and the second wire 8 may be an insulated wire in which such a conductive core is covered with an insulating coating. The wire size (diameter) of each of the first wire 7 and the second wire 8 is not limited and is, for example, 1.0 to 3.0 mm. The diameters of the first wire 7 and the second wire 8 may be equal to or different from each other. For example, the diameter of the first wire 7 and the second wire 8 through which a larger electric current flows may be larger than the diameter of the other wire.

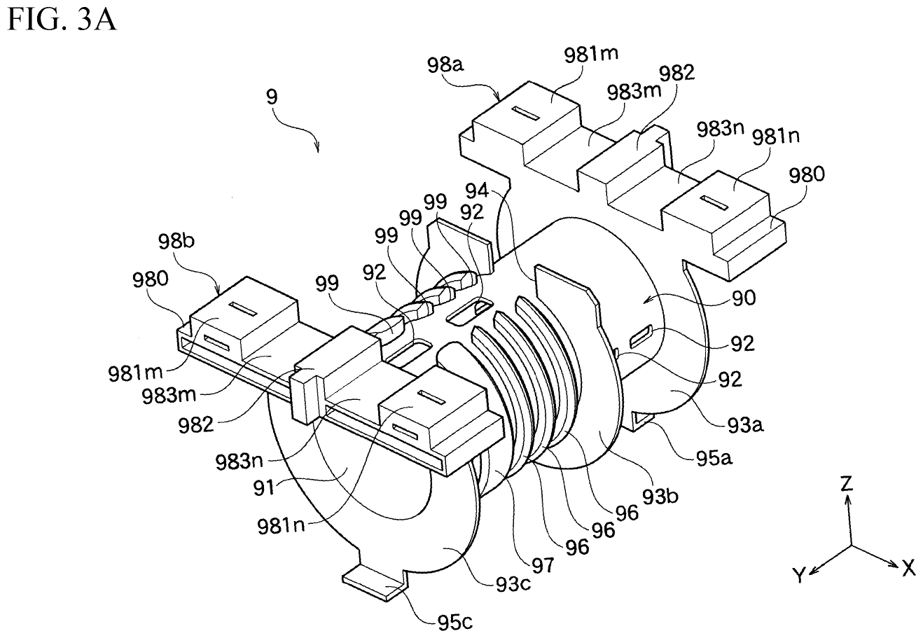

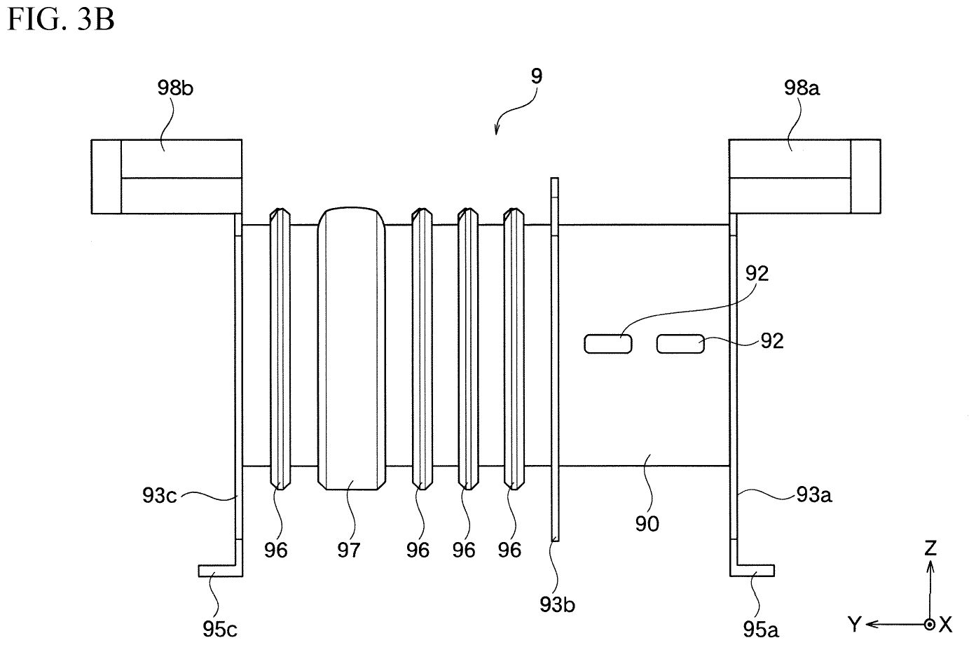

The bobbin 9 shown in FIG. 3A is made of plastic such as PPS, PET, PBT, and LCP or other insulating materials (e.g., heat-resistant material). As an example, the bobbin 9 includes a cylinder 90, flanges 93a to 93c, legs 95a and 95c, protrusions 96, a wide convex portion 97, and terminal blocks 98a and 98b.

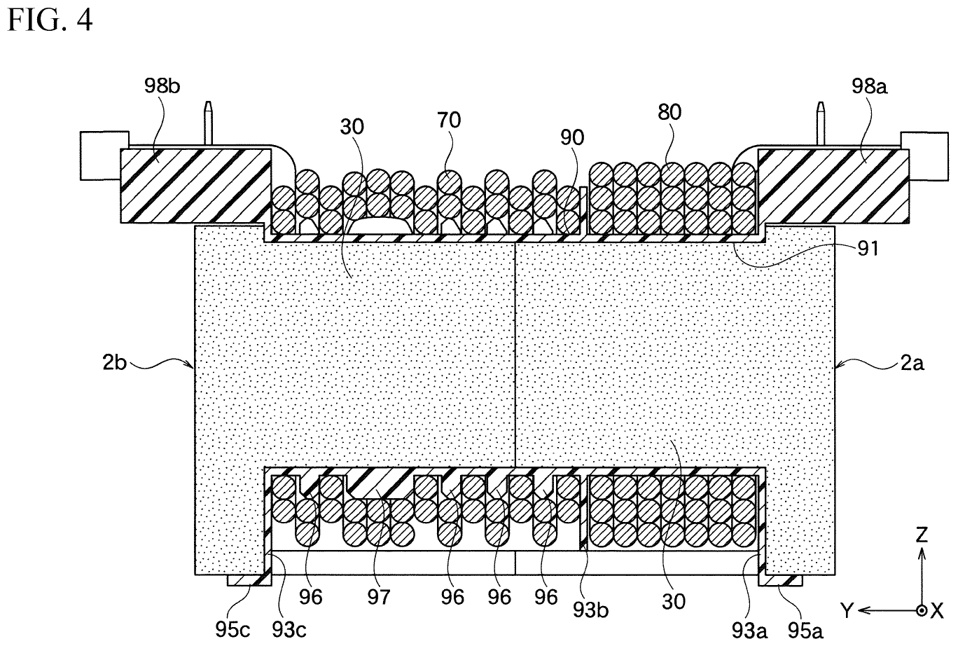

The cylinder 90 is a bottomless cylindrical body and includes a through hole 91. The axial direction of the cylinder 90 corresponds to the Y-axis direction and is parallel to the bottom portion 60 of the case 6 (FIG. 1). The cross-sectional shape of the cylinder 90 is circular, but may be elliptical or polygonal. From the viewpoint of winding the first wire 7 and the second wire 8 on the outer circumferential surface of the cylinder 90 at high density (increasing the space factor), however, the cross-sectional shape of the cylinder 90 is preferably circular. As shown in FIG. 4, a part of each of the cores 2a and 2b (middle leg 30) is inserted into the through hole 91. The first wire 7 is wound around the outer circumferential surface of the cylinder 90 to form the first winding portion 70. Also, the second wire 8 is wound around the outer circumferential surface of the cylinder 90 to form the second winding portion 80. The first winding portion 70 and the second winding portion 80 are arranged next to each other along the Y-axis.

As shown in FIG. 3A, a plurality of circulation holes 92 is formed on the outer circumferential surface of the cylinder 90. The inside of the case 6 shown in FIG. 1 is filled with a heat dissipating resin. The circulation holes 92 shown in FIG. 3A are holes provided so as to allow the heat dissipating resin to flow in and out of the cylinder 90. The circulation holes 92 are formed at the top of the cylinder 90 (a portion of the cylinder 90 on the positive side in the Z-axis direction), at the bottom of the cylinder 90 (a portion of the cylinder 90 on the negative side in the Z-axis direction), and at the middle of the cylinder 90 (a portion of the cylinder 90 located between its top and bottom).

The flange 93a is formed at one end of the cylinder 90 in its axial direction, and the flange 93c is formed at the other end of the cylinder 90 in its axial direction. The flange 93b is located between the flange 93a and the flange 93c. The flange 93b is closer to the flange 93a than to the flange 93c. However, the flange 93b may be located at a central part of the cylinder 90 in its axial direction or may be closer to the flange 93c than to the flange 93a.

The flanges 93a to 93c protrude from the outer circumferential surface of the cylinder 90 toward the outside in its axial direction. Also, the flanges 93a to 93c extend along the circumferential direction of the cylinder 90. As shown in FIG. 2, the second winding portion 80 is disposed between the flange 93a and the flange 93b, and the first winding portion 70 is disposed between the flange 93b and the flange 93c. The protrusion length of the flanges 93a to 93c toward the outside in their radial direction is not limited, but is twice or more the wire size of the first wire 7 or the second wire 8.

As shown in FIG. 3A, the flange 93b is provided with a communication portion 94. The communication portion 94 is formed between one end and the other end of the flange 93b in its extension direction (circumferential direction). The communication portion 94 is a passage for communicating one side and the other side of the flange 93b in the Y-axis direction. For example, the first wire 7 or the second wire 8 may be inserted from one side to the other side of the flange 93b in the Y-axis direction via the communication portion 94.

The leg 95a is formed on the bottom of the flange 93a, and the leg 95c is formed on the bottom of the flange 93c. The legs 95a and 95c are configured to support the bobbin 9 and are installed on the bottom portion 60 of the case 6 (FIG. 1).

A plurality of convex portions 96 and one wide convex portion 97 are formed on the outer circumferential surface of the cylinder 90. As shown in FIG. 3B, the number of convex portions 96 is four, but may be one to three or five or more. The number of wide convex portions 97 is one, but may be multiple. Three convex portions 96 are arranged along the axial direction of the cylinder 90 between the flange 93b and the wide convex portion 97. One convex portion 96 is disposed between the flange 93c and the wide convex portion 97. The wide convex portion 97 is disposed so as to be sandwiched between the convex portion 96 on one side of the wide convex portion 97 in the Y-axis direction and the convex portion 96 on the opposite side of the wide convex portion 97 in the Y-axis direction.

The plurality of convex portions 96 and the wide convex portion 97 are arranged at equal intervals along the Y-axis between the flange 93b and the flange 93c. However, the installation intervals of the plurality of convex portions 96 and the wide convex portion 97 do not have to be equal to each other. The interval between the convex portions 96 next to each other is larger than the wire size of the first wire 7 or the second wire 8. Thus, the first wire 7 or the second wire 8 can be disposed between one convex portion 96 and the other convex portion 96 next to each other. Note that, the same applies to the interval between the convex portion 96 and the flange 93b, the interval between the convex portion 96 and the flange 93c, and the interval between the wide convex portion 97 and the convex portion 96, and each of these intervals is larger than the wire size of the first wire 7 or the second wire 8.

As shown in FIG. 3A, the convex portions 96 protrude outward in the radial direction of the cylinder 90 and extend along the circumferential direction of the cylinder 90. The protrusion length of each convex portion 96 protruding outward in the radial direction is not limited and may be, for example, equal to or larger than the wire size of the first wire 7 or the second wire 8.

The width of each convex portion 96 along the Y-axis is not limited, but is, for example, ½ times or more and 2 times or less the wire size of the first wire 7 or the second wire 8. Each convex portion 96 has a tapered shape that tapers outward in the radial direction. This is to facilitate the entry of the first wire 7 between one convex portion 96 and the other convex portion 96 next to each other.

A notch 99 is formed between one end and the other end of each convex portion 96 in its extension direction (circumferential direction). The first wire 7 can be inserted (transferred) from one side to the other side of each convex portion 96 in the Y-axis direction via the notch 99.

The wide convex portion 97 protrudes outward in the radial direction of the cylinder 90 and extends along the circumferential direction of the cylinder 90. The protrusion length of the wide convex portion 97 toward the outside in the radial direction is not limited and may be, for example, equal to or larger than the wire size of the first wire 7 or the second wire 8. The protrusion length of the wide convex portion 97 toward the outside in the radial direction is equal to the protrusion length of each convex portion 96 toward the outside in the radial direction, but may be larger or smaller than the protrusion length of each convex portion 96 toward the outside in the radial direction.

The width of the wide convex portion 97 along the Y-axis is not limited and is, for example, two times or more and five times or less the wire size of the first wire 7 or the second wire 8. The wide convex portion 97 has a tapered shape that tapers outward in its radial direction (see FIG. 3B). This is to facilitate the entry of the first wire 7 between the wide convex portion 97 and each convex portion 96.

A notch 99 is formed between one end and the other end of the wide convex portion 97 in its extension direction (circumferential direction). The first wire 7 can be inserted (transferred) from one side to the other side of the wide convex portion 97 in the Y-axis direction via the notch 99.

The terminal block 98a is formed at the top of the flange 93a (the portion on the positive side in the Z-axis) and protrudes outward from the flange 93a along the Y-axis. The terminal block 98b is formed at the top of the flange 93c and protrudes outward from the flange 93c along the Y-axis. The terminal blocks 98a and 98b have the same configuration, but may have different configurations. As an example, each of the terminal blocks 98a and 98b includes a base 980, terminal fixation portions 981m and 981n, a partition 982, and guide grooves 983m and 983n.

The base 980 is a flat plate having a rectangular shape in plan view. The terminal fixation portion 981m is formed on one side of the base 980 in the X-axis direction and protrudes from the base 980 along the Z-axis. The terminal fixation portion 981n is formed on the opposite side of the base 980 in the X-axis direction and protrudes from the base 980 along the Z-axis. The partition 982 is located between the terminal fixation portion 981m and the terminal fixation portion 981n and protrudes from the base 980 along the Z-axis. In addition, a part of the partition 982 protrudes outward from the base 980 along the Y-axis.

The guide groove 983m is a groove formed between the partition 982 and the terminal fixation portion 981m and extends along the Y-axis. The guide groove 983n is a groove formed between the partition 982 and the terminal fixation portion 981n and extends along the Y-axis.

As shown in FIG. 2 and FIG. 3A, the lead portion 71a is led out from the first winding portion 70 and guided to the guide groove 983m of the terminal block 98b. Also, the lead portion 71b is led out from the first winding portion 70 and guided to the guide groove 983n of the terminal block 98b. Also, the lead portion 81a is led out from the second winding portion 80 and guided to the guide groove 983m of the terminal block 98a. Also, the lead portion 81b is led out from the second winding portion 80 and guided to the guide groove 983n of the terminal block 98a.

As shown in FIG. 2, the terminal 10a is fixed integrally to the terminal fixation portion 981m of the terminal block 98b. Also, the terminal 10b is fixed integrally to the terminal fixation portion 981n of the terminal block 98b. Also, the terminal 10c is fixed integrally to the terminal fixation portion 981m of the terminal block 98a. Also, the terminal 10d is fixed integrally to the terminal fixation portion 981n of the terminal block 98a. The terminals 10a to 10d are integrally formed with the terminal fixation portion 981m or 981n, but may be configured to be retrofittable to the terminal fixation portion 981m or 981n.

The terminals 10a to 10d have the same shape and include, as an example, wire connection portions 11a to 11d, mounting portions 12a to 12d, and intermediate portions 13a to 13d, respectively. Each of the wire connection portions 11a to 11d has a caulked portion. The lead portion 71a is connected to the wire connection portion 11a while being caulked. The lead portion 71b is connected to the wire connection portion 11b while being caulked. The lead portion 81a is connected to the wire connection portion 11c while being caulked. The lead portion 81b is connected to the wire connection portion 11d while being caulked.

The lead portions 71a, 71b, 81a, and 81b are laser-welded to the wire connection portions 11a to 11d. However, the lead portions 71a, 71b, 81a, and 81b may be connected to the wire connection portions 11a to 11d by, for example, solder, conductive adhesive, thermocompression bonding, ultrasonic bonding, resistance brazing, ultraviolet curing resin bonding, etc.

The mounting portions 12a to 12d are portions that can be connected to a mounting board (not shown). The mounting portion 12a protrudes outward along the Z-axis from the terminal fixation portion 981m of the terminal block 98b. The mounting portion 12b protrudes outward along the Z-axis from the terminal fixation portion 981n of the terminal block 98b. The mounting portion 12c protrudes outward along the Z-axis from the terminal fixation portion 981m of the terminal block 98a. The mounting portion 12d protrudes outward along the Z-axis from the terminal fixation portion 981n of the terminal block 98a.

The intermediate portions 13a to 13d are portions located between the wire connection portions 11a to 11d and the mounting portions 12a to 12d. A part of the intermediate portion 13a is embedded in the terminal fixation portion 981m of the terminal block 98b. A part of the intermediate portion 13b is embedded in the terminal fixation portion 981n of the terminal block 98b. A part of the intermediate portion 13c is embedded in the terminal fixation portion 981m of the terminal block 98a. A part of the intermediate portion 13d is embedded in the terminal fixation portion 981n of the terminal block 98a.

As shown in FIG. 4, the first winding portion 70 is formed between the flange 93b and the flange 93c. The number of layers of the first winding portion 70 in its radial direction is two, but may be one or three or more. Some turns of the first layer of the first winding portion 70 are arranged between one convex portion 96 and the other convex portion 96 next to each other. Also, some turns of the first layer of the first winding portion 70 are arranged between the convex portion 96 and the flange 93b or between the convex portion 96 and the flange 93c. Also, some turns of the first layer of the first winding portion 70 are arranged between the wide convex portion 97 and the convex portion 96.

Some turns of the second layer of the first winding portion 70 are arranged on the turns of the first layer of the first winding portion 70. Note that, some turns of the second layer of the first winding portion 70 may be arranged so as to overlap with the turns of the first layer of the first winding portion 70 and the convex portion 96. Alternatively, some turns of the second layer of the first winding portion 70 may be arranged so as to overlap with the turns of the first layer of the first winding portion 70 and the wide convex portion 97.

In the first layer of the first winding portion 70, since the convex portion 96 is interposed between one turn and the other turn next to each other, one turn and the other turn are spaced apart along the Y-axis. Thus, it is possible to adjust the leakage magnetic flux between the first winding portion 70 and the second winding portion 80. Note that, two or more turns may be arranged side by side along the Y-axis between one convex portion 96 and the other convex portion 96 next to each other. Alternatively, two or more turns may be stacked along the protrusion direction of the convex portion 96 between one convex portion 96 and the other convex portion 96 next to each other. The same applies to between the convex portion 96 and the wide convex portion 97, the convex portion 96 and the flange 93b, and the convex portion 96 and the flange 93c.

When one turn and the other turn are in contact with the convex portion 96 (or the wide convex portion 97, the flange 93b, and the flange 93c), the winding positions of these turns are fixed, and it is possible to prevent variations in the winding shape and winding position of the first winding portion 70. This makes it easy to adjust the leakage magnetic flux between the first winding portion 70 and the second winding portion 80. Note that, one turn and/or the other turn may be spaced apart from the convex portion 96, etc.

The second winding portion 80 is formed between the flange 93a and the flange 93b. The number of layers of the second winding portion 80 in its radial direction is three, but may be one, two, or four or more. The number of layers of the second winding portion 80 in its radial direction is larger than the number of layers of the first winding portion 70 in its radial direction, but may be equal to or smaller than the number of layers of the first winding portion 70 in its radial direction. The number of layers of the second winding portion 80 in the Y-axis is smaller than the number of layers of the first winding portion 70 in the Y-axis, but may be equal to or larger than the number of layers of the first winding portion 70 in the Y-axis.

The case (shield) 6 shown in FIG. 1 is made of a metal with excellent cooling properties, such as aluminum, copper, and silver. The case 6 is provided with an opening for accommodating the cores 2a and 2b, the bobbin 9, and the first and second winding portions 70 and 80. The inside of the case 6 can be filled with a heat dissipating resin via the opening of the case 6. The heat dissipating resin is made of silicone resin, urethane resin, epoxy resin, or the like. The heat dissipating resin is filled close to the opening of the case 6, for example, up to about 70 to 90% of the height of a side portion 61 of the case 6.

The cores 2a and 2b, the bobbin 9, the first winding portion 70, and the second winding portion 80 are covered with the heat dissipating resin filled in the case 6. However, the terminal blocks 98a and 98b of the bobbin 9 protrude from the opening of the case 6 and are exposed from the heat dissipating resin in the case 6.

In the present embodiment, it is possible to efficiently dissipate heat from the first winding portion 70, the second winding portion 80, the cores 2a and 2b, the bobbin 9, and the like to the outside via the case 6 and further via the heat dissipating resin and to improve the heat dissipation or cooling efficiency of the transformer 1.

The case 6 includes, for example, a bottom portion 60, a side portion 61, and protrusion portions 62a and 62b. The bottom portion 60 has a rectangular shape in plan view, but the shape of the bottom portion 60 may be a circle, an ellipse, a square, or another polygon. The cores 2a and 2b are arranged on the bottom portion 60. The cores 2a and 2b are arranged so as to be in contact with the bottom portion 60, but an insulating or conductive member may be interposed between the cores 2a and 2b and the bottom portion 60.

The side portion 61 extends along the outer edge of the bottom portion 60 and protrudes from the bottom portion 60 along the Z-axis. The side portion 61 includes a first surface 61a, a second surface 61b opposing to the first surface 61a along the Y-axis, a third surface 61c perpendicular to the first surface 61a, and a fourth surface 61d opposing to the third surface 61c along the X-axis.

The protrusion portion 62a protrudes outward along the Y-axis from the first surface 61a of the side portion 61. The protrusion portion 62b protrudes outward along the Y-axis from the first surface 61b of the side portion 61.

As shown in FIG. 2, the cores 2a and 2b are E-shaped cores and have the same shape. The material of the cores 2a and 2b is, for example, a metal or a magnetic material such as ferrite. The core 2a is attached to the cylinder 90 of the bobbin 9 from one side in the Y-axis direction. The core 2b is attached to the cylinder 90 from the other side in the Y-axis direction. Thus, the cores 2a and 2b are arranged so as to oppose to each other along the axial direction of the cylinder 90.

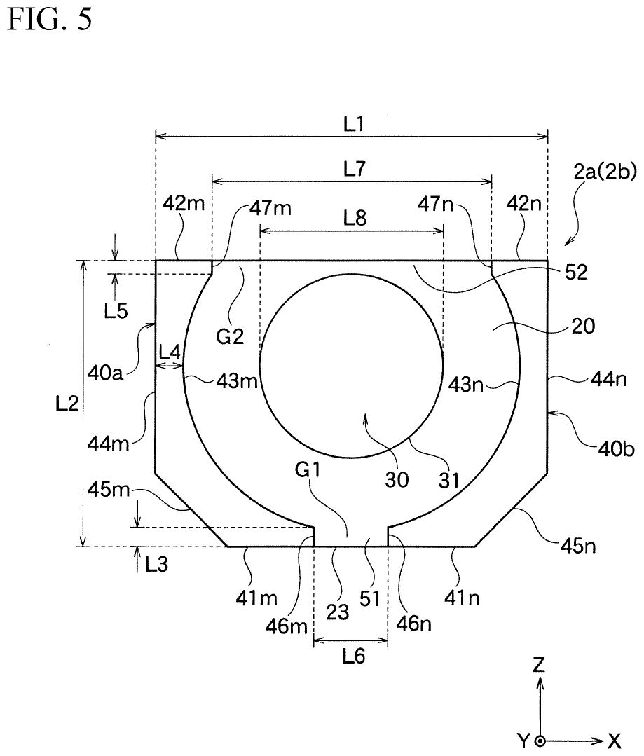

The core 2a includes a bottom plate 20, a middle leg 30, and outer legs 40a and 40b. The bottom plate 20 is a flat plate having a flat rectangular parallelepiped shape. As shown in FIG. 5, the length L1 of the bottom plate 20 along the X-axis is larger than the length L2 of the bottom plate 20 along the Z-axis. However, L1=L2 may be satisfied, or L1<L2 may be satisfied. As shown in FIG. 2, the bottom plate 20 includes a first main surface 21, a second main surface 22, a bottom end surface 23, a top end surface 24, side end surfaces 25 and 26, and chamfered portions 27.

The first main surface 21 is one main surface (wide surface) of the bottom plate 20, and the second main surface 22 is the other main surface of the bottom plate 20. The first main surface 21 and the second main surface 22 are flat surfaces parallel to each other and oppose to each other along the Y-axis. The second main surface 22 of the core 2a oppose to the second surface 61b of the side portion 61 of the case 6 (FIG. 1) along the Y-axis. The second main surface 22 of the core 2b oppose to the first surface 61a of the side portion 61 of the case 6 (FIG. 1) along the Y-axis.

The bottom end surfaces 23, the top end surfaces 24, and the side end surfaces 25 and 26 are formed along the outer edge of the bottom plate 20 and constitute an outer end surface (narrow surface) of the bottom plate 20. The outer end surface of the bottom plate 20 is a surface perpendicular to the first main surface 21 and the second main surface 22.

The bottom end surfaces 23 and the top end surfaces 24 are flat surfaces parallel to each other and oppose to each other along the Z-axis. The bottom end surfaces 23 oppose to the bottom portion 60 of the case 6 (FIG. 1). The bottom end surfaces 23 of the cores 2a and 2b are in contact with the bottom portion 60, but a conductive or insulating member may be disposed between the bottom end surfaces 23 and the bottom portion 60. The top end surface 24 is a surface opposing to the opening of the case 6 (FIG. 1). The top end surface 24 of the core 2a opposes to the terminal block 98a of the bobbin 9 along the Z-axis. The top end surface 24 of the core 2b opposes to the terminal block 98b of the bobbin 9 along the Z-axis.

The side end surface 25 and the side end surface 26 are flat surfaces parallel to each other and oppose to each other along the X-axis. The side end surface 25 of the core 2a is disposed so as to oppose to the fourth surface 61d of the side portion 61 of the case 6 (FIG. 1), and the side end surface 25 of the core 2b is disposed so as to oppose to the third surface 61c of the side portion 61. The side end surface 26 of the core 2a is disposed so as to oppose to the third surface 61c of the side portion 61, and the side end surface 26 of the core 2b is disposed so as to oppose to the fourth surface 61d of the side portion 61. The side end surfaces 25 and 26 are arranged apart from the side portion 61 of the case 6, but may be in contact with the side portion 61.

A chamfered portion 27 is formed on the ridge portion between the side end surface 25 and the bottom end surface 23 (the intersection portion between the side end surface 25 and the bottom end surface 23). Likewise, a chamfered portion 27 is formed on the ridge portion between the side end surface 26 and the bottom end surface 23 (the intersection portion between the side end surface 26 and the bottom end surface 23). The chamfered portions 27 extend obliquely with respect to the bottom end surface 23 (or the side end surfaces 25 and 26). Since the chamfered portions 27 are formed on both sides of the bottom end surface 23 in the X-axis direction, the bottom plate 20 has a shape tapering toward the bottom end surface 23.

The middle leg 30 protrudes inward (the bobbin 9 side) along the Y-axis from the first main surface 21 of the bottom plate 20. The middle leg 30 is located between a pair of outer legs 40a and 40b. The middle leg 30 is located at a central part of the bottom plate 20 in the X axis direction, but may be offset from the center of the bottom plate 20. The transverse cross-sectional shape of the middle leg 30 (cross-sectional shape of the middle leg 30 perpendicular to its axial direction) corresponds to the transverse cross-sectional shape of the cylinder 90 of the bobbin 9 and is circular. However, the transverse cross-sectional shape of the middle leg 30 may be elliptical or polygonal.

A tip 32 of the middle leg 30 of the core 2a and a tip 32 of the middle leg 30 of the core 2b are butted together so as to be in contact with each other along the Y-axis. However, a gap may be formed along the Y-axis between the tip 32 of the middle leg 30 of the core 2a and the tip 32 of the middle leg 30 of the core 2b.

The outer legs 40a and 40b are located opposite to each other along the X-axis. The outer leg 40a and the outer leg 40b protrude along the Y-axis from the first main surface 21 of the bottom plate 20 on both sides of the middle leg 30. The length of each of the outer legs 40a and 40b along the Y-axis is the same as the length of the middle leg 30 along the Y-axis, but may be larger or smaller than the length of the middle leg 30 along the Y-axis.

As shown in FIG. 5, the outer leg 40a includes an outer end surface (first outer end surface) 41m, an outer end surface (second outer end surface) 42m, an inner side surface 43m, an outer side surface 44m, a chamfered portion 45m, a first gap forming surface 46m, and a second gap forming surface 47m. The outer leg 40b has the same shape as the outer leg 40a and includes an outer end surface (third outer end surface) 41n, an outer end surface (fourth outer end surface) 42n, an inner side surface 43n, an outer side surface 44n, a chamfered portion 45n, a first gap forming surface 46n, and a second gap forming surface 47n.

In the outer leg 40a, the outer end surface (first outer end surface) 41m, the outer end surface (second outer end surface) 42m, and the outer side surface 44m constitute the outer edge of the outer leg 40a. The outer end surface 41m and the outer end surface 42m are flat surfaces parallel to each other. The outer end surface 41m opposes to the bottom portion 60 of the case 6 (FIG. 1). The outer end surface 41m is disposed so as to be in contact with the bottom portion 60, but a conductive or insulating member may be disposed between the outer end surface 41m and the bottom portion 60. The outer end surface 42m is located opposite to the outer end surface 41m in the direction perpendicular to the outer end surface 41m (i.e., the Z-axis direction).

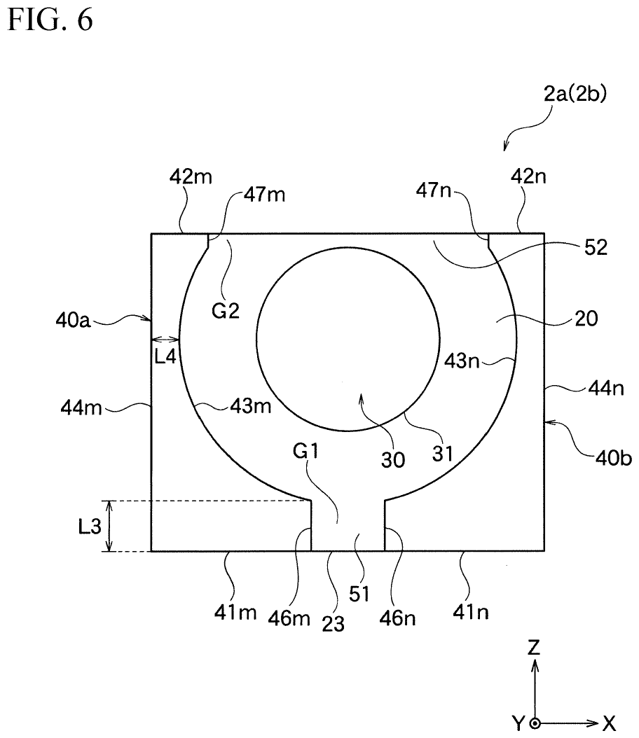

In the example shown in FIG. 5, since the outer leg 40a is provided with the chamfered portion 45m, the outer end surface 41m and the outer end surface 42m do not oppose to each other. As shown in FIG. 6, however, if the outer leg 40a is not provided with the chamfered portion 45m, at least a part of the outer end surface 41m and the outer end surface 42m oppose to each other along the Z-axis. As shown in FIG. 5, the length of the outer end surface 41m along the X-axis is larger than the length of the outer end surface 42m along the X-axis, but may be equal to or smaller than the length of the outer end surface 42m along the X-axis.

The inner surface (inner circumferential surface) 43m extends along the outer circumferential surface 31 of the middle leg 30 on the outer side of the middle leg 30 in its radial direction. In the gap between the inner side surface 43m and the outer circumferential surface 31, the cylinder 90 (FIG. 2) of the bobbin 9 and the first winding portion 70 (FIG. 2) or the second winding portion 80 wound around the cylinder 90 are arranged. The inner side surface 43m is curved along the outer circumferential surface 31 of the middle leg 30, but at least a part of the inner side surface 43m may extend linearly.

The outer side surface 44m is located opposite to the inner side surface 43m in the X-axis direction and intersects with the outer end surface 41m and the outer end surface 42m. A part of the outer side surface 44m extends along the side end surface 25 (FIG. 2) of the bottom plate 20 and extends in the direction perpendicular to the outer end surface 42m. The outer side surface 44m is smoothly connected (continuous) to the side end surface 25, and no step is formed between the outer side surface 44m and the side end surface 25. The outer side surface 44m (FIG. 2) of the core 2a opposes to the fourth surface 61d of the side portion 61 of the case 6 (FIG. 1), and the outer side surface 44m (FIG. 2) of the core 2b opposes to the third surface 61c of the side portion 61.

As shown in FIG. 5, the chamfered portion 45m is formed on a remaining part of the outer side surface 44m and extends in a direction inclined with respect to the outer end surface 41m. The chamfered portion 45m is formed on the ridge portion between the outer end surface 41m and the outer side surface 44m (the intersection portion between the outer end surface 41m and the outer side surface 44m). The chamfered portion 45m of the outer side surface 44m is smoothly connected (continuous) to the chamfered portion 27 (FIG. 2) of the bottom plate 20, and no step is formed between the chamfered portion 45m and the chamfered portion 27.

In this way, since the chamfered portion 45m is formed on the ridge portion between the outer end surface 41m and the outer side surface 44m, it is possible to prevent cracks or chips from occurring on the ridge portion between the outer end surface 41m and the outer side surface 44m. This makes it possible to prevent variations in the cross-sectional area of the magnetic path formed by the outer leg 40a and to prevent variations in the magnetic characteristics of the transformer 1.

The first gap forming surface 46m extends in a direction perpendicular to the outer end surface 41m so as to connect the outer end surface 41m and the inner side surface 43m. The first gap forming surface 46m may extend so as to be inclined with respect to the outer end surface 41m. The second gap forming surface 47m extends in a direction perpendicular to the outer end surface 42m so as to connect the outer end surface 42m and the inner side surface 43m. The second gap forming surface 47m may extend so as to be inclined with respect to the outer end surface 42m. The first gap forming surface 46m and the second gap forming surface 47m extend in parallel, but may extend in non-parallel.

In the outer leg 40b, the outer end surface (third outer end surface) 41n, the outer end surface (fourth outer end surface) 42n, and the outer side surface 44n constitute the outer edge of the outer leg 40b. The outer end surface 41n and the outer end surface 42n are flat surfaces parallel to each other. The outer end surface 41n opposes to the bottom portion 60 of the case 6 (FIG. 1). The outer end surface 41n is disposed so as to be in contact with the bottom portion 60, but a conductive or insulating member may be disposed between the outer end surface 41n and the bottom portion 60. The outer end surface 42n is located opposite to the outer end surface 41n in the direction perpendicular to the outer end surface 41n (i.e., the Z-axis direction).

In the example shown in FIG. 5, since the outer leg 40b is provided with the chamfered portion 45n, the outer end surface 41n and the outer end surface 42n do not oppose to each other. As shown in FIG. 6, however, if the outer leg 40b is not provided with the chamfered portion 45n, at least a part of the outer end surface 41n and the outer end surface 42n oppose to each other along the Z-axis. As shown in FIG. 5, the length of the outer end surface 41n along the X-axis is larger than the length of the outer end surface 42n along the X-axis, but may be equal to or smaller than the length of the outer end surface 42n along the X-axis.

The inner surface (inner circumferential surface) 43n extends along the outer circumferential surface 31 of the middle leg 30 on the outer side of the middle leg 30 in its radial direction. In the gap between the inner side surface 43n and the outer circumferential surface 31, the cylinder 90 (FIG. 2) of the bobbin 9 and the first winding portion 70 (FIG. 2) or the second winding portion 80 wound around the cylinder 90 are arranged. The inner side surface 43n is curved along the outer circumferential surface 31 of the middle leg 30, but at least a part of the inner side surface 43n may extend linearly.

The outer side surface 44n is located opposite to the inner side surface 43n in the X-axis direction and intersects with the outer end surface 41n and the outer end surface 42n. A part of the outer side surface 44n extends along the side end surface 26 (FIG. 2) of the bottom plate 20 and extends in the direction perpendicular to the outer end surface 42n. The outer side surface 44n is smoothly connected (continuous) to the side end surface 26, and no step is formed between the outer side surface 44n and the side end surface 26. The outer side surface 44n (FIG. 2) of the core 2a opposes to the third surface 61c of the side portion 61 of the case 6 (FIG. 1), and the outer side surface 44n of the core 2b opposes to the fourth surface 61d of the side portion 61.

As shown in FIG. 5, the chamfered portion 45n is formed on a remaining part of the outer side surface 44n and extends in a direction inclined with respect to the outer end surface 41n. The chamfered portion 45n is formed on the ridge portion between the outer end surface 41n and the outer side surface 44n (the intersection portion between the outer end surface 41n and the outer side surface 44n). The chamfered portion 45n of the outer side surface 44n is smoothly connected (continuous) to the chamfered portion 27 (FIG. 2) of the bottom plate 20, and no step is formed between the chamfered portion 45n and the chamfered portion 27.

The first gap forming surface 46n extends in a direction perpendicular to the outer end surface 41n so as to connect the outer end surface 41n and the inner side surface 43n. The first gap forming surface 46n may extend so as to be inclined with respect to the outer end surface 41n. The second gap forming surface 47n extends in a direction perpendicular to the outer end surface 42n so as to connect the outer end surface 42n and the inner side surface 43n. The second gap forming surface 47n may extend so as to be inclined with respect to the outer end surface 42n. The first gap forming surface 46n and the second gap forming surface 47n extend in parallel, but may extend in non-parallel.

A part of the bottom end surface 23 of the bottom plate 20 extends along the X-axis between the outer end surface 41m and the outer end surface 41n. The bottom end surface 23 extends continuously (smoothly) with respect to the outer end surface 41m and the outer end surface 41n. The bottom end surface 23, the outer end surface 41m, and the outer end surface 41n are all flat surfaces and are flush with each other. Thus, no steps or recesses are formed on the bottom end surface 23.

The first gap forming surface 46m and the first gap forming surface 46n oppose to each other along the X-axis. A first gap G1 is formed between the first gap forming surface 46m and the first gap forming surface 46n. The second gap forming surface 47m and the second gap forming surface 47n oppose to each other along the X-axis. A second gap G2 is formed between the second gap forming surface 47m and the second gap forming surface 47n.

A first opening 51 is formed between the outer end surface 41m and the outer end surface 41n. The first opening 51 is an end of the first gap G1 along the Z-axis and opens toward the bottom portion 60 of the case 6 (FIG. 1). A second opening 52 is formed between the outer end surface 42m and the outer end surface 42n. The second opening 52 is an end of the second gap G2 along the Z-axis and opens toward the opening of the case 6 (FIG. 1).

As shown in FIG. 1, the first opening 51 extends in the Y-axis along the bottom portion 60 of the case 6. In the core 2a or 2b, as shown in FIG. 2, the first opening 51 extends in the Y-axis from the roots of the outer legs 40a and 40b (intersections between the outer legs 40a and 40b and the bottom plate 20) to the tips of the outer legs 40a and 40b. In a state in which the cores 2a and 2b are combined (see FIG. 1), the first opening 51 extends along the Y-axis from the roots of the outer legs 40a and 40b of the core 2a to the roots of the outer legs 40a and 40b of the core 2b.

As shown in FIG. 5, a width L6 of the first opening 51 along the X-axis is smaller than a width L7 of the second opening 52 along the X-axis. This is to prevent leakage magnetic flux from flowing out of the core 2a (2b) via the first opening 51. Then, this is to prevent leakage magnetic flux from interlinking with the bottom portion 60 of the case 6 (FIG. 1) and, moreover, to prevent eddy currents from occurring in the bottom portion 60. The ratio L6/L7 of L6 to L7 is not limited. For example, 1/10≤L6/L7≤4/5, 1/5≤L6/L7≤3/5, or 1/5≤L6/L7≤1/2 is satisfied. Note that, L6/L1 is not limited, where L1 is a length of the core 2a (2b) along the X-axis. For example, 1/20≤L6/L1≤1/2 or 1/10<L6/L1≤1/3 is satisfied.

The width L6 of the first opening 51 along the X-axis is smaller than a width L8 of the middle leg 30 along the X-axis (the diameter of the middle leg 30 in the present embodiment). The ratio L6/L8 of L6 to L8 is not limited. For example, 1/10≤ L6/L8<4/5 or 1/5<L6/L8≤3/5 may be satisfied. In this case, leakage magnetic flux is less likely to flow out toward the bottom portion 60 (FIG. 1) via the first opening 51. Thus, leakage magnetic flux is less likely to interlink with the bottom portion 60, and it is possible to effectively prevent eddy currents from occurring in the bottom portion 60. Moreover, the outer circumferential surface of the first winding portion 70 (or the second winding portion 80) disposed around the middle leg 30 is less likely to be exposed to the outside of the first opening 51 (i.e., the bottom portion 60 side). Thus, in this respect as well, leakage magnetic flux is less likely to interlink with the bottom portion 60, and it is possible to effectively prevent eddy currents from occurring in the bottom portion 60.

The center (axis) of the middle leg 30 is offset from the center of the bottom plate 20 to one side (the opening side of the case 6 in FIG. 1) along the Z-axis. Thus, the middle leg 30 is closer to the second opening 52 than to the first opening 51. In this case, the first winding portion 70 (FIG. 2) or the second winding portion 80 disposed around the middle leg 30 is disposed closer to the second opening 52 than to the first opening 51. In this way, since the first winding portion 70, and the like are unevenly located closer to the second opening 52, the outer circumferential surface of the first winding portion 70, and the like are less likely to be exposed to the outside of the first opening 51 (i.e., the bottom portion 60 side of the case 6 in FIG. 1). Thus, leakage magnetic flux is less likely to interlink with the bottom portion 60, and it is possible to effectively prevent eddy currents from occurring in the bottom portion 60.

A thickness LA along the X-axis between the inner side surface 43m and the outer side surface 44m increases toward the second opening 52. The same applies to the thickness along the X-axis between the inner side surface 43n and the outer side surface 44n. Then, the outer legs 40a and 40b are curved (protrude) toward the center of the bottom plate 20 in the X-axis direction along the outer circumferential surface 31 of the middle leg 30 on the second opening 52 side. Thus, the width L8 of the second opening 52 along the X-axis can be reduced so that the magnetic path formed by the first outer leg 40a and the second outer leg 40b can easily form a closed magnetic path. As a result, more magnetic flux passes through the outer legs 40a and 40b, and the magnetic characteristics of the transformer 1 can be improved.

Moreover, the thickness LA along the X-axis between the inner side surface 43m and the outer side surface 44m decreases toward the center of the outer leg 40a in the Z-axis direction. The same applies to the thickness along the X-axis between the inner side surface 43n and the outer side surface 44n. Thus, the thickness of the outer leg 40a along the X-axis can be reduced at a central part of the outer leg 40a in the Z-axis direction, and the core 2a (2b) can be downsized.

A minimum thickness L3 along the Z-axis between the outer end surface 41m and the inner side surface 43m (i.e., a length of the first gap forming surface 46m along the Z-axis) is smaller than a minimum thickness LA along the X-axis between the outer side surface 44m and the inner side surface 43m. As shown in FIG. 6, however, the minimum thickness L3 along the Z-axis between the outer end surface 41m and the inner side surface 43m may be larger than the minimum thickness L4 along the X-axis between the outer side surface 44m and the inner side surface 43m. The same applies to the minimum thickness along the Z-axis between the outer end surface 41n and the inner side surface 43n. The core 2a (2b) shown in FIG. 6 is formed so that the thickness along the Z-axis between the outer end surface 41m and the inner side surface 43m is larger than that of the core 2a (2b) shown in FIG. 5.

In the example shown in FIG. 6, the cross-sectional area of the magnetic path formed by the outer leg 40a can be larger than that in the example shown in FIG. 5, and the magnetic characteristics of the transformer 1 can be improved. Moreover, when the first winding portion 70 (FIG. 2) or the second winding portion 80 is disposed around the middle leg, the outer circumferential surface of the first winding portion 70 or the second winding portion 80 is disposed at a position spaced from the first opening 51 toward the second opening 52 according to the thickness L3 between the outer end surface 41m and the inner side surface 43m. Thus, the outer circumferential surface of the first winding portion 70 or the second winding portion 80 is less likely to be exposed to the outside of the first opening 51 (i.e., the bottom portion 60 side of the case 6 in FIG. 1). As a result, leakage magnetic flux is less likely to interlink with the bottom portion 60, and it is possible to effectively prevent eddy currents from occurring in the bottom portion 60.

As shown in FIG. 5, the minimum thickness L3 along the Z-axis between the outer end surface 41m and the inner side surface 43m is larger than a minimum thickness L5 along the Z-axis between the outer end surface 42m and the inner side surface 43m (i.e., the length of the second gap forming surface 47m along the Z-axis). The same applies to the minimum thickness along the Z-axis between the outer end surface 41n and the inner side surface 43n. In this case as well, the outer circumferential surface of the first winding portion 70 or the second winding portion 80 is disposed at a position spaced away from the first opening 51 toward the second opening 52 according to the thickness L3 between the outer end surface 41m and the inner side surface 43m. Thus, the outer circumferential surface of the first winding portion 70 or the second winding portion 80 is less likely to be exposed to the outside of the first opening 51 (i.e., the bottom portion 60 side of the case 6 in FIG. 1), and leakage magnetic flux can be prevented from interlinking with the bottom portion 60. Note that, L3=L5 or L3<L5 may be satisfied.

Next, a method of manufacturing a transformer 1 is described. First, each member shown in FIG. 1 and FIG. 2 is prepared. As shown in FIG. 2, terminals 10c and 10d are integrally formed with a terminal block 98a of a bobbin 9, and terminals 10a and 10b are integrally formed with a terminal block 98b of the bobbin 9. Next, a first wire 7 is wound around a cylinder 90 between a flange 93b and a flange 93c of the bobbin 9 to form a first winding portion 70. In addition, a second wire 8 is wound around the cylinder 90 between a flange 93a and the flange 93b of the bobbin 9 to form a second winding portion 80.

Next, a first lead portion 71a is led out toward the terminal block 98b, and the first lead portion 71a is caulked to a wire connection portion 11a of the terminal 10a. Also, a first lead portion 71b is led out toward the terminal block 98b, and the first lead portion 71b is caulked to a wire connection portion 11b of the terminal 10b. Also, a second lead portion 81a is led out toward the terminal block 98a, and the second lead portion 81a is caulked to a wire connection portion 11c of the terminal 10c. Also, a second lead portion 81b is led out toward the terminal block 98a, and the second lead portion 81b is caulked to a wire connection portion 11d of the terminal 10d. Then, for example, a laser is irradiated to the vicinity of the wire connection portions 11a to 11d to integrate the lead portions with the wire connection portions 11a to 11d.

Next, a middle leg 30 of the core 2a is inserted into a through hole of the cylinder 90, and the core 2a is attached to the bobbin 9. Also, a middle leg 30 of the core 2b is inserted into a through hole of the cylinder 90, and the core 2b is attached to the bobbin 9. If necessary, a tip 32 of the middle leg 30 of the core 2a and a tip 32 of the middle leg 30 of the core 2b may be bonded to each other with an adhesive, etc. The tip of the outer leg 40a (40b) of the core 2a and the tip of the outer leg 40a (40b) of the core 2b may be bonded to each other with an adhesive, etc.

Next, as shown in FIG. 1, the bobbin 9 with the cores 2a and 2b, etc. is housed inside a case 6. At this time, the bobbin 9 with the cores 2a and 2b, etc. is housed inside the case 6 so that outer end surfaces 41m and 41n (FIG. 5) oppose to the bottom portion 60 of the case 6. Next, if necessary, the inside of the case 6 is filled with a heat dissipating resin. Accordingly, a transformer 1 shown in FIG. 1 can be manufactured.

As described above, in the present embodiment, as shown in FIG. 5, the outer leg 40a includes the outer end surface 41m opposing to the bottom portion 60 of the case 6 (FIG. 1), and the outer leg 40b includes the outer end surface 41n opposing to the bottom portion 60. Thus, the first opening 51 formed between the outer end surface 41m and the outer end surface 41n is necessarily opened toward the bottom portion 60. In this way, since the first opening 51 is opened toward the bottom portion 60, the first opening 51 functions as a heat dissipation path. As a result, heat from the core 2a, the core 2b, the first winding portion 70, the second winding portion 80, etc. is easily dissipated toward the bottom portion 60, and the heat dissipation of the transformer 1 can be improved. Moreover, when the inside of the case 6 is filled with a heat dissipation resin, the heat dissipation resin flows out toward the bottom portion 60 via the first opening 51. Thus, the heat dissipation resin is easily distributed all over in the case 6, and the heat dissipation of the transformer 1 can further be improved.

The width L6 of the first opening 51 formed between the outer end surface 41m and the outer end surface 41n is smaller than the width L7 of the second opening 52 formed between the outer end surface 42m and the outer end surface 42n. In this case, leakage magnetic flux is less likely to flow out toward the bottom portion 60 (FIG. 1) via the first opening 51. Thus, leakage magnetic flux is less likely to interlink with the bottom portion 60, and it is possible to prevent eddy currents from occurring in the bottom portion 60. This makes it possible to reduce the loss of the transformer 1 and to increase the efficiency of the transformer 1.

Accordingly, in the present embodiment, it is not necessary to increase the distance between the cores 2a and 2b and the bottom portion 60 for the purpose of reducing the loss of the transformer 1, and the transformer 1 can be downsized. Moreover, it is not necessary to dispose a magnetic material between the cores 2a and 2b and the bottom portion 60 so as to block leakage magnetic flux, and the manufacturing cost does not increase. Thus, according to the present embodiment, it is possible to provide a small-sized, low-loss transformer 1 without increasing the manufacturing cost.

Also, as shown in FIG. 2, the bottom end surface 23 extending along the X-axis is formed at the outer edge of the bottom plate 20 at least between the outer end surface 41m (FIG. 5) and the outer end surface 41n (FIG. 5), and the bottom end surface 23 is a flat surface. Thus, compared to the case where the bottom end surface 23 is a concave surface, a gap is less likely to be formed between the bottom end surface 23 and the bottom portion 60 of the case 6 (FIG. 1). Thus, leakage magnetic flux is less likely to flow out to the outside of the bottom plate 20 via the gap. As a result, leakage magnetic flux is less likely to interlink with the bottom portion 60, and it is possible to effectively prevent eddy currents from occurring in the bottom portion 60.

Also, as shown in FIG. 5, no step is formed between the outer end surface 41m and the bottom end surface 23, and no step is formed between the outer end surface 41n and the bottom end surface 23. In this case as well, a gap is less likely to be formed between the bottom end surface 23 and the bottom portion 60 of the case 6 (FIG. 1), and leakage magnetic flux is less likely to flow out to the outside of the bottom plate 20 via the gap. Thus, leakage magnetic flux is less likely to interlink with the bottom portion 60, and it is possible to effectively prevent eddy currents from occurring in the bottom portion 60.

Note that, the present disclosure is not limited to the above-described embodiment and may variously be modified within the scope of the present disclosure.

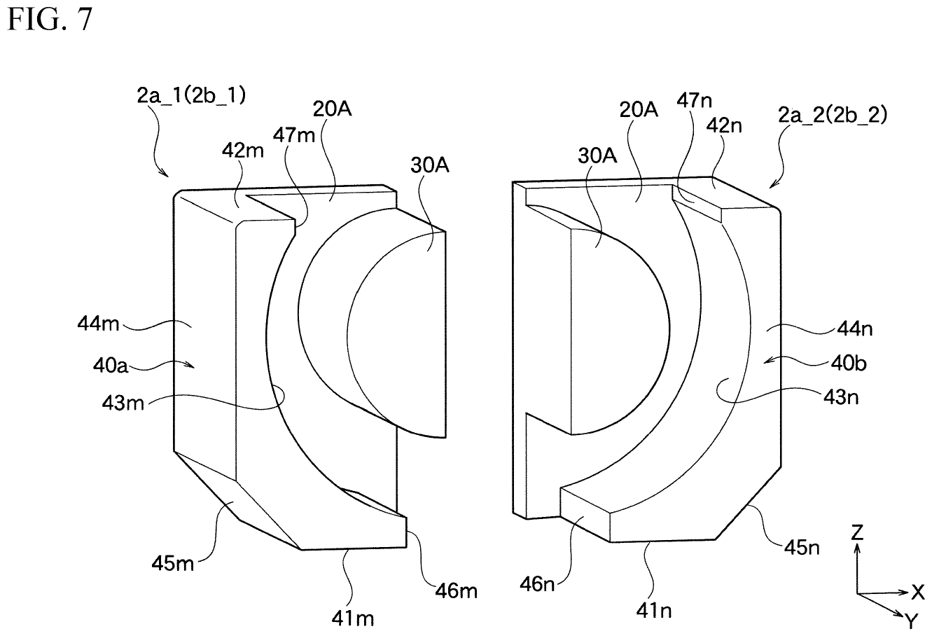

(1) As shown in FIG. 7, the core 2a shown in FIG. 2 may consist of two split cores 2a_1 and 2a_2 obtained by splitting the core 2a in two. Each of the split cores 2a_1 and 2a_2 includes a bottom plate 20A and a middle leg 30A. The bottom plate 20A has a shape obtained by splitting the bottom plate 20 of the core 2a shown in FIG. 2 in two. The middle leg 30A has a shape obtained by splitting the middle leg 30 of the core 2a shown in FIG. 2 in two. Thus, the transverse cross-sectional shape of the middle leg portion 30A is semicircular. The core 2a shown in FIG. 2 can be formed by combining the split core 2a_1 and the split core 2a_2 along the X-axis. Accordingly, since the split cores 2a_1 and 2a_2 are combined, the core loss can be reduced, and the efficiency of the transformer 1 can be increased.

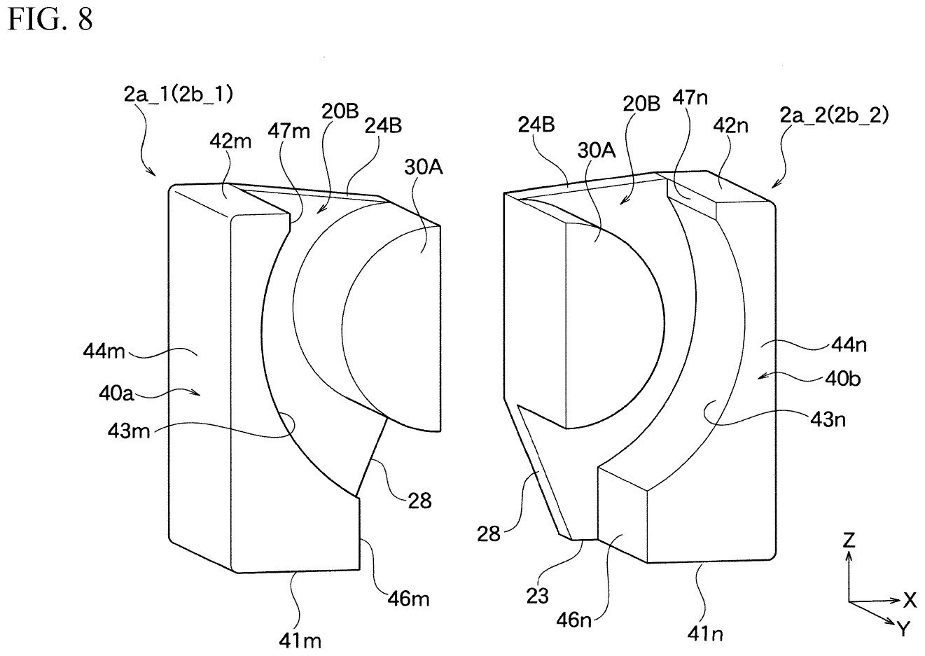

(2) As shown in FIG. 8, the core 2a shown in FIG. 6 may consist of two split cores 2a_1 and 2a_2 obtained by splitting the core 2a in two. The core 2a shown in FIG. 6 can be formed by combining the split cores 2a_1 and 2a_2 along the X-axis. Accordingly, since the split cores 2a_1 and 2a_2 are combined, the core loss can be reduced, and the efficiency of the transformer 1 can be increased. Note that, a top end surface 24B of a bottom plate 20B is inclined so as to approach the middle leg 30 toward the center of the bottom plate 20 in the X-axis direction. Moreover, an inclined surface 28 inclined with respect to the bottom end surface 23 is formed on the outer edge of the bottom plate 20B.

(3) In the above-mentioned embodiment, both of the cores 2a and 2b are E-shaped cores, but either one of the cores 2a and 2b may be an I-shaped core. Alternatively, the cores 2a and 2b may be U-shaped cores.

(4) In the above-mentioned embodiment, the bottom end surface 23 and/or the top end surface 24 of the bottom plate 20 shown in FIG. 2 may be an inclined surface or an uneven surface.

(5) In the above-mentioned embodiment, the transformer 2 shown in FIG. 2 is provided with the bobbin 9, but the bobbin 9 may be omitted from the configuration of the transformer 1. In this case, the first wire 7 and the second wire 8 may be wound directly or indirectly around the middle legs 30 of the cores 2a and 2b.

(6) In the above-mentioned embodiment, as shown in FIG. 1, the transformer 1 is provided with the case 6 as a shield including the bottom portion 60, the side portion 61, and the protrusion portions 62a and 62b. However, the shield is not limited to a case-shaped member and may be a metal plate-shaped member. For example, the case 6 omitting the side portion 61 and the protrusion portions 62a and 62b and including only the bottom portion 60 may be used as a shield.

(7) The present disclosure may be applied to coil devices other than transformers, such as inductors.

### DESCRIPTION OF THE REFERENCE NUMERICAL

1 . . . transformer
2a, 2b, 2a_1, 2b_1, 2a_2, 2b_2 . . . core
20, 20A, 20B . . . bottom plate
21 . . . first main surface
22 . . . second main surface
23 . . . bottom end surface
24, 24B . . . top end surface
25, 26 . . . side end surface
27 . . . chamfered portion
28 . . . inclined surface
30, 30A . . . middle leg
31 . . . outer circumferential surface
32 . . . tip
40a, 40b . . . outer leg
41m, 41n, 42m, 42n . . . outer end surface (first outer end surface to fourth outer end surface)
43m, 43n . . . inner side surface
44m, 44n . . . outer side surface
45m, 45n . . . chamfered portion
46m, 46n . . . first gap forming surface
47m, 47n . . . second gap forming surface
51 . . . first opening
52 . . . second opening
6 . . . case
60 . . . bottom portion
61 . . . side portion
61a-61d . . . first surface to fourth surface
62a, 62b . . . protrusion portion
7 . . . first wire
70 . . . first winding portion
71a, 71b . . . first lead portion
8 . . . second wire
80 . . . second winding portion
81a, 81b . . . second lead portion
9 . . . bobbin
90 . . . cylinder
91 . . . through hole
92 . . . circulation hole
93a-93c . . . flange
94 . . . communication portion
95a, 95c . . . leg
96 . . . convex portion
97 . . . wide convex portion
98a, 98b . . . terminal block
980 . . . base
981m, 981n . . . terminal fixation portion
982 . . . partition
983m, 983n . . . guide groove
99 . . . notch
10a-10d . . . terminal
11a-11d . . . wire connection portion
12a-12d . . . mounting portion
13a-13d . . . intermediate portion
G1 . . . first gap
G2 . . . second gap

1.-8. (canceled)

9. A transformer comprising:
a core including:
a bottom plate;
a middle leg protruding from the bottom plate; and
a first outer leg and a second outer leg located opposite to each other along a first axis and protruding from the bottom plate on both sides of the middle leg; and
a metal shield in which the core is placed;
wherein
the first outer leg includes:
a first outer end surface opposing to the shield; and
a second outer end surface located on the opposite side of the first outer end surface with respect to a direction perpendicular to the first outer end surface,
the second outer leg includes:
a third outer end surface opposing to the shield; and
a fourth outer end surface located on the opposite side of the third outer end surface with respect to a direction perpendicular to the third outer end surface, and
a width of a first opening, formed between the first outer end surface and the third outer end surface, along the first axis is smaller than a width of a second opening, formed between the second outer end surface and the fourth outer end surface, along the first axis.

10. The transformer according to claim 9, wherein the width of the first opening along the first axis is smaller than a width of the middle leg along the first axis.

11. The transformer according to claim 9, wherein the middle leg is closer to the second opening than to the first opening.

12. The transformer according to claim 9, wherein
the first outer leg includes:
a first inner side surface extending along an outer circumferential surface of the middle leg; and
a first outer side surface intersecting the first outer end surface and the second outer end surface, and
a thickness between the first outer end surface and the first inner side surface is larger than a thickness between the first outer side surface and the first inner side surface.

13. The transformer according to claim 9, wherein
the first outer leg includes:
a first inner side surface curved along an outer circumferential surface of the middle leg; and
a first outer side surface intersecting the first outer end surface and the second outer end surface, and
a thickness between the first inner side surface and the first outer side surface increases toward the second opening.

14. The transformer according to claim 9, wherein
the first outer leg includes a first outer side surface intersecting the first outer end surface and the second outer end surface, and
a ridge portion between the first outer end surface and the first outer side surface is chamfered.

15. The transformer according to claim 9, wherein
a bottom end surface extending along the first axis is formed at an outer edge of the bottom plate at least between the first outer end surface and the third outer end surface, and
the bottom end surface is a flat surface.

16. The transformer according to claim 15, wherein
no step is formed between the first outer end surface and the bottom end surface, and
no step is formed between the third outer end surface and the bottom end surface.
